(19) United States
(12) Patent Application Publication
(10) Pub. No.: US 2025/0028513 A1
(43) Pub. Date: Jan. 23, 2025

(54) CONTROL DEVICE THAT CONTROLS EXTENDED FUNCTION OF ROBOT OR MACHINE TOOL AND USER INTERFACE DEVICE

(71) Applicant: Fanuc Corporation, Yamanashi (JP)

(72) Inventors: Kensuke AYATO, Minamitsuru-gun, Yamanashi (JP); Takahiro TANAKA, Minamitsuru-gun, Yamanashi (JP); Akihiro YANAGITA, Minamitsuru-gun, Yamanashi (JP)

(73) Assignee: Fanuc Corporation, Yamanashi (JP)

(21) Appl. No.: 18/714,864

(22) PCT Filed: Dec. 9, 2021
(86) PCT No.: PCT/JP2021/045387

§ 371 Date: May 30, 2024

(51) Int. Cl. G06F 8/61; B25J 13/06

(52) U.S. Cl. CPC G06F 8/61; B25J 13/06

(57) ABSTRACT

A control device that controls the extended functions of a robot or machine tool on the basis of installed extended software includes: an extended software validity/invalidity storage unit that stores validity/invalidity information indicating whether each extended software stored in an extended software candidate storage unit that stores installation candidate extended software is valid or invalid; and an extended software installation processing unit that executes an installation process on the extended software indicated as valid in the validity/invalidity information stored in the extended software validity/invalidity storage unit, from among the extended software stored in the extended software candidate storage unit.

### CROSS REFERENCE TO RELATED APPLICATIONS

This is the U.S. National Phase application of PCT/JP2021/045387 filed Dec. 9, 2021, the disclosure of this application being incorporated herein by reference in its entirety for all purposes.

### FIELD OF THE INVENTION

The present invention relates to a controller for controlling an extension function of a robot or a machine tool, and a user interface device.

### BACKGROUND OF THE INVENTION

An industrial robot and an industrial machine tool have basic motion controlled based on “standard software” being installed (implemented) in advance. Further, a robot and a machine tool have a high degree of flexibility and can be applied to various applications (uses), and a function may be further extended or changed by using a specific connection apparatus according to a purpose. Such a function being extended or changed later is also referred to as an “extension function” or an “optional function”. An extension function of an industrial robot and an industrial machine tool is controlled based on “extension software” being additionally installed (implemented) after shipment to a factory, for example. Further, even an application of the same kind may require an extension function peculiar to each user (customer), and, in such a case, installation of extension software exclusively for each user is needed.

For example, a processing device has been known that processes a processed object, and includes: a holding means for holding the processed object; a processing means for processing the processed object held by the holding means; a control means including a program storage unit configured to store a program for operating the processing means; and a reading means for reading external instruction information, the control means includes: a special program storage unit configured to store a special program; and an installation execution unit configured to install the special program, and the installation execution unit includes: an instruction information recording unit in which instruction information associated with the special program is recorded; and an instruction information determination unit configured to compare instruction information to be read by the reading means with instruction information recorded in advance in the instruction information recording unit, and permit installation when there is coinciding instruction information (see, for example, PTL 1).

### PATENT LITERATURE

[PTL 1] JP 2014-026435A

### SUMMARY OF THE INVENTION

At a time of shipment, what kind of application (use) a robot is to be used is often undecided. Thus, there are needs to be able to install (implement) all pieces of extension software for all applications in advance in a controller at a time of shipment of a robot, and selectively activate only necessary extension software again by a simple operation when an application using the robot is determined.

Further, when a plurality of pieces of extension software are installed at the same time on one controller for different applications, there is a possibility that a malfunction and a failure may occur in a robot and a machine tool due to an interaction between the pieces of extension software. Setting information about communication with a connection apparatus, setting information about a coordinate system of a robot, setting information about a load, and the like may vary by application. Since the pieces of setting information are stored in a storage region commonly used by each piece of extension software in a robot controller, the pieces of setting information may compete with each other when a plurality of pieces of extension software are installed.

According to one aspect of the present disclosure, a controller that controls an extension function of a robot or a machine tool, based on installed extension software, includes: an extension software activation/deactivation storage unit configured to store activation/deactivation information indicating whether each piece of the extension software stored in an extension software candidate storage unit configured to store the extension software being an installation candidate is activated or deactivated; and an extension software installation processing unit configured to perform installation processing on extension software indicated to be activated in the activation/deactivation information stored in the extension software activation/deactivation storage unit among the pieces of extension software stored in the extension software candidate storage unit.

Further, according to one aspect of the present disclosure, a controller that controls an extension function of a robot or a machine tool, based on installed extension software, includes: a whole setting storage unit configured to store, for at least one piece of extension software installed on the controller, setting information data in which various pieces of setting information about the extension function in the extension software are defined; an activation setting storage unit configured to store setting information data to be used when the extension function is controlled based on extension software installed on the controller; and a setting activation processing unit configured to write, into the activation setting storage unit, setting information data that are selected from among pieces of the setting information data stored in the whole setting storage unit and need to be activated.

Further, according to one aspect of the present disclosure, a user interface device for a controller that controls an extension function of a robot or a machine tool, based on installed extension software, is configured to perform control for displaying, on a display device, an extension software list display item indicating a list of pieces of extension software being installation candidates stored in an extension software candidate storage unit, an activation/deactivation information display item indicating whether each piece of the extension software being the installation candidate is activated or deactivated, and a setting menu display item that prompts setting as to whether to activate or deactivate each piece of the extension software being the installation candidate.

Further, according to one aspect of the present disclosure, a user interface device for a controller that controls an extension function of a robot or a machine tool, based on installed extension software, is configured to perform control for displaying, on a display device, a setting information data list display item indicating a list of pieces of setting information data in which various pieces of setting information about the extension function of at least one piece of extension software installed on the controller are defined, an activation/deactivation information display item indicating whether each piece of setting information data in the setting information data list display item is activated or deactivated, and a setting menu display item that prompts setting as to whether to activate or deactivate each piece of setting information data in the setting information data list display item.

According to one aspect of the present disclosure, in a controller that controls an extension function of a robot or a machine tool, based on installed extension software, and a user interface device, desired extension software can be selectively installed by a simple operation without occurrence of a malfunction and a failure due to an interaction between pieces of extension software and competition between pieces of setting information.

### BRIEF DESCRIPTION OF DRAWINGS

FIG. 1 is a block diagram illustrating a controller according to one embodiment of the present disclosure.

FIG. 2 is a block diagram illustrating a case where an extension software candidate storage unit is formed outside the controller according to one embodiment of the present disclosure.

FIG. 3 is a diagram illustrating a file configuration of extension software.

FIG. 4 is a block diagram illustrating especially an element related to installation processing of the extension software among elements constituting the controller illustrated in FIG. 1.

FIG. 5 is a diagram (part 1) illustrating a screen displayed on an indicator of a teaching pendant by a user interface device according to one embodiment of the present disclosure.

FIG. 6 is a diagram (part 2) illustrating a screen displayed on the indicator of the teaching pendant by the user interface device according to one embodiment of the present disclosure.

FIG. 7 is a diagram (part 3) illustrating a screen displayed on the indicator of the teaching pendant by the user interface device according to one embodiment of the present disclosure.

FIG. 8 is a block diagram illustrating the controller further including an authentication unit in a modification example of one embodiment of the present disclosure, and illustrates a case where the extension software candidate storage unit is provided in the controller.

FIG. 9 is a block diagram illustrating the controller further including the authentication unit in a modification example of one embodiment of the present disclosure, and illustrates a case where the extension software candidate storage unit is provided outside the controller.

FIG. 10 is a diagram illustrating an authentication screen displayed on the indicator of the teaching pendant by the user interface device according to one embodiment of the present disclosure.

FIG. 11 is a block diagram illustrating especially an element related to activation processing of setting information data among the elements constituting the controller illustrated in FIG. 1.

FIG. 12 is a diagram illustrating an activation setting screen of setting information data displayed on the indicator of the teaching pendant by the user interface device according to one embodiment of the present disclosure.

FIG. 13 is a diagram illustrating a series of flows of detachment of a hand B and attachment of a hand A with respect to a robot.

FIG. 14 is a diagram illustrating the teaching pendant that displays a teaching program for controlling detachment of the hand B and attachment of the hand A illustrated in FIG. 13.

FIG. 15 is a diagram illustrating a screen of the indicator of the teaching pendant in which information about a command of extension software for setting information data not being activated is hidden by the user interface device according to one embodiment of the present disclosure.

FIG. 16 is a diagram illustrating a screen when an alarm about execution of extension software for setting information data not being activated is displayed on the indicator of the teaching pendant by the user interface device according to one embodiment of the present disclosure.

### DETAILED DESCRIPTION OF EMBODIMENTS OF THE INVENTION

Hereinafter, a controller for controlling an extension function of a robot or a machine tool, and a user interface device for the controller will be described with reference to drawings. The same member is denoted by the same reference sign in each of the drawings. Further, a scale is changed in the drawings as appropriate in order to facilitate understanding. An illustrated aspect is one example for implementation, and the present disclosure is not limited to the illustrated aspect.

The controller according to one embodiment of the present disclosure is a robot controller that controls a robot or a numerical controller that controls a machine tool. Herein, as one example, a case where the controller is a robot controller that controls a robot will be described, but the following description can also be similarly applied to a numerical controller that controls a machine tool.

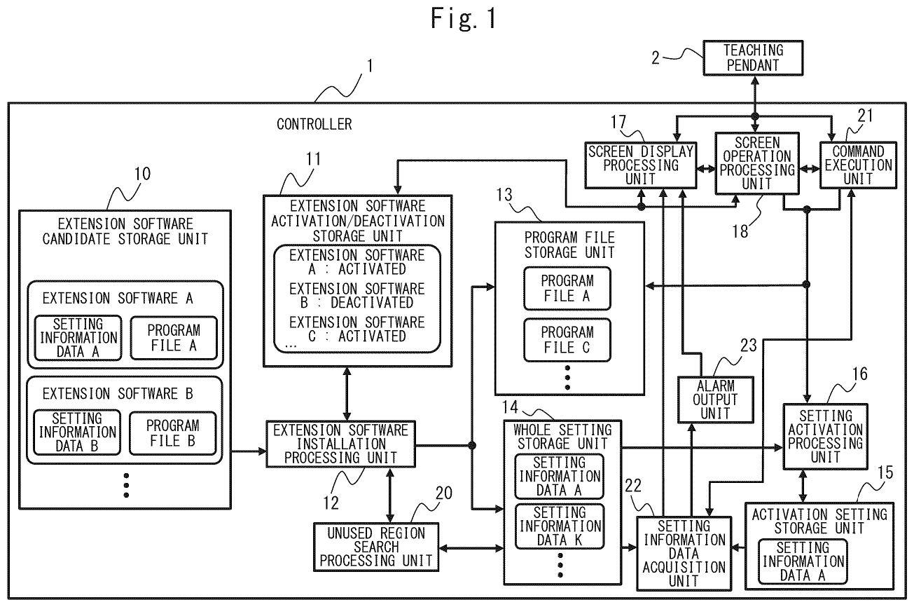

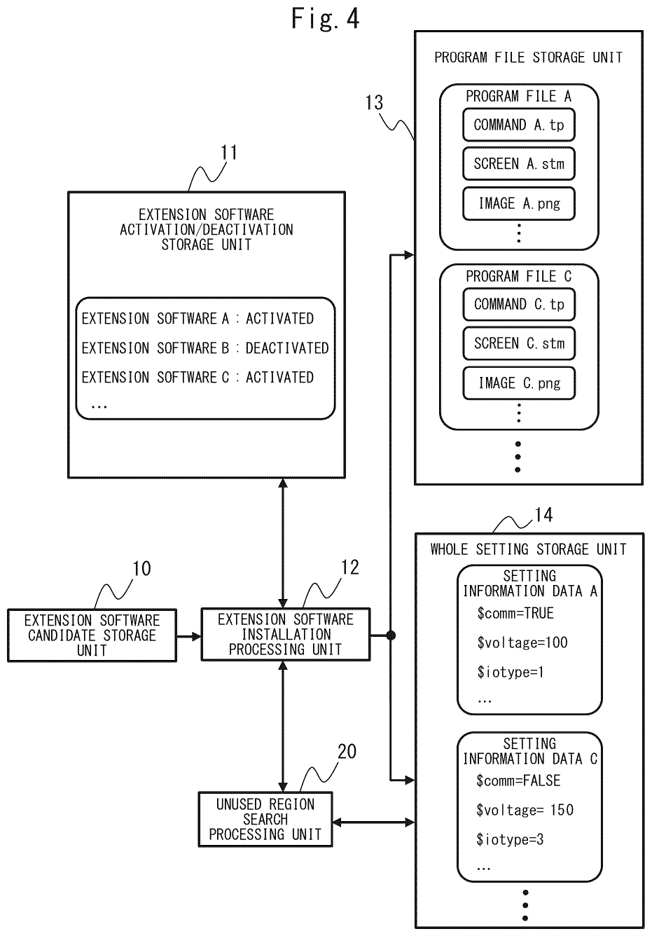

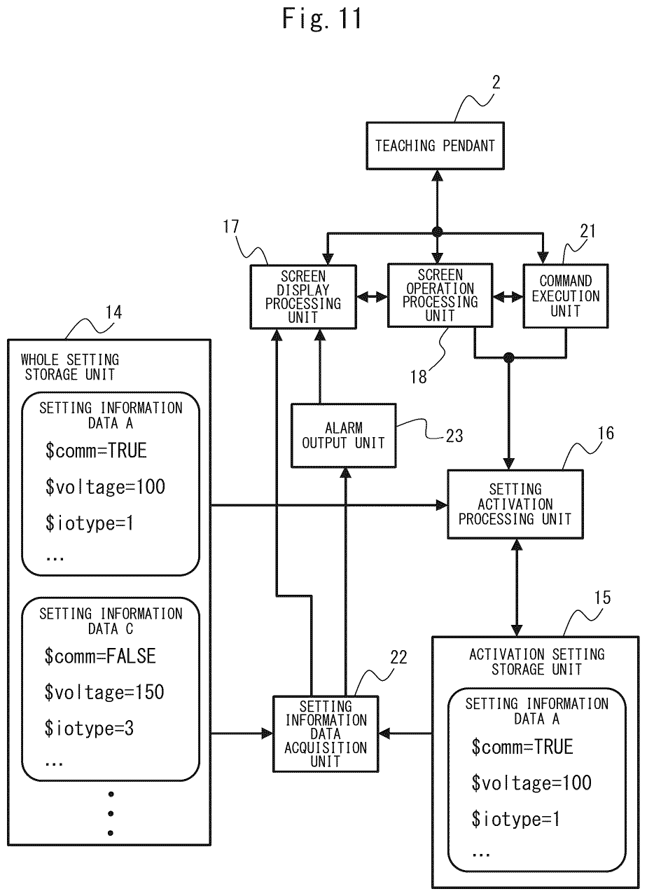

FIG. 1 is a block diagram illustrating the controller according to one embodiment of the present disclosure. FIG. 4 is a block diagram illustrating especially an element related to installation processing of extension software among elements constituting the controller illustrated in FIG. 1. FIG. 11 is a block diagram illustrating especially an element related to activation processing of setting information data among the elements constituting the controller illustrated in FIG. 1.

A controller 1 being a robot controller controls a robot by standard software for controlling a standard function of the robot and extension software for controlling an extension function. Examples of the extension software include extension software for controlling a specific connection apparatus of a robot, extension software for causing an arm of a robot to perform a special movement, extension software for causing a main body (base) of a robot to perform a special movement, and the like, but may include the other extension software. Further, examples of the extension software for controlling a specific connection apparatus of a robot include extension software for controlling a specific hand attached to a robot, extension software for controlling a specific tool attached to a robot, extension software for controlling a specific camera attached to a robot, extension software for controlling a specific sensor attached to a robot, and the like, but may include the other extension software.

In one embodiment of the present disclosure, a plurality of pieces of extension software being installation candidates are stored in advance in an extension software candidate storage unit 10. The pieces of extension software being the installation candidates stored in the extension software candidate storage unit 10 are not directly used for control of an extension function of the controller 1. For control of an extension function of the controller 1, extension software selected as extension software needed to be activated from among the pieces of extension software being the installation candidates is used. In other words, the controller 1 controls the extension function of the robot, based on extension software selectively installed from among the plurality of pieces of extension software being the installation candidates. In order for the controller 1 to appropriately control the extension function of the robot, extension software corresponding to the extension function needs to be installed (implemented) on the controller 1, and setting information corresponding to the extension function also needs to be activated.

As illustrated in FIG. 1, a teaching pendant 2 is connected to the controller 1 in a wireless or wired manner. In order to selectively install extension software that needs to be activated, the controller 1 includes an extension software activation/deactivation storage unit 11, an extension software installation processing unit 12, and a program file storage unit 13. Further, in order to selectively activate setting information, the controller 1 includes a whole setting storage unit 14, an activation setting storage unit 15, a setting activation processing unit 16, an unused region search processing unit 20, a setting information data acquisition unit 22, and an alarm output unit 23. Further, the controller 1 includes the extension software candidate storage unit 10, a screen display processing unit 17, a screen operation processing unit 18, and a command execution unit 21. It is noted that the screen display processing unit 17 may be formed as a part of a function of the screen operation processing unit 18.

The extension software candidate storage unit 10 is used for storing extension software being an installation candidate. The extension software stored in the extension software candidate storage unit 10 is merely an installation candidate, and is not directly used for control of an extension function of the controller 1 when the extension software is just stored in the extension software candidate storage unit 10. Thus, the extension software candidate storage unit 10 does not need to be a storage device that can be written and read at a high speed, and an inexpensive storage device that can be written and read at a low speed can be used. Further, the extension software candidate storage unit 10 is preferably a mass storage device in order to be able to store a plurality of pieces of extension software being installation candidates. Examples of the extension software candidate storage unit 10 include a hard disk drive (HD), a solid state drive (SSD), a flash memory, and the like. There is an advantage that a greater number of pieces of extension software stored in the extension software candidate storage unit 10 increases freedom of selection of extension software that can be installed on the controller 1.

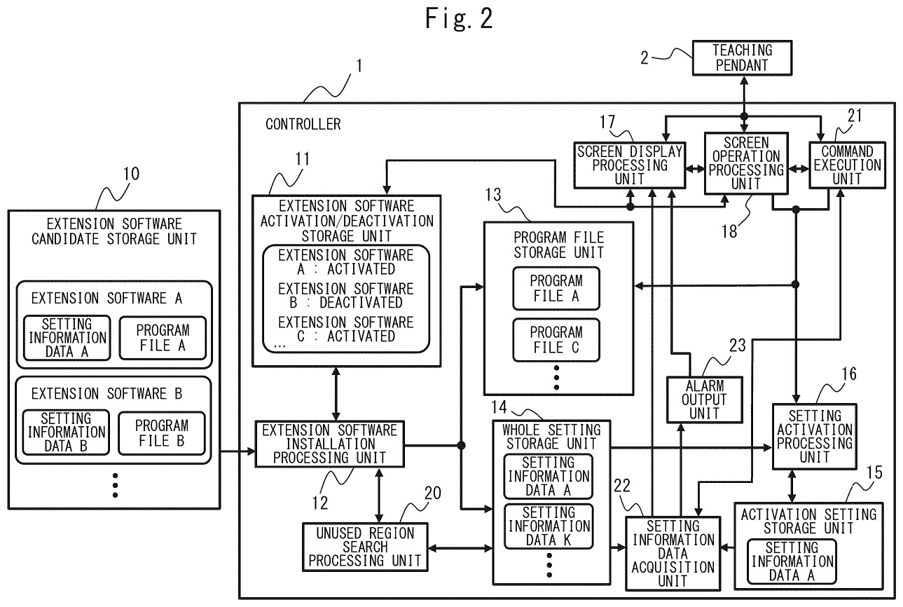

In the example illustrated in FIG. 1, the extension software candidate storage unit 10 is provided inside the controller 1. As the alternative example, the extension software candidate storage unit 10 may be provided outside the controller 1. FIG. 2 is a block diagram illustrating a case where the extension software candidate storage unit is formed outside the controller according to one embodiment of the present disclosure. As the extension software candidate storage unit 10 provided outside the controller 1, there are a USB memory (USB flash drive), a memory card, a network storage, an optical disk, a magnetic disk, and the like.

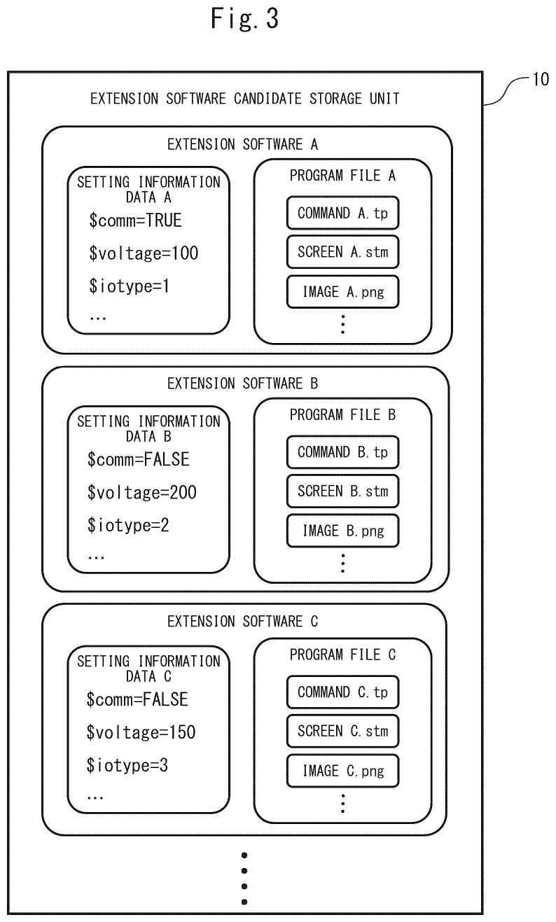

FIG. 3 is a diagram illustrating a file configuration of extension software.

The extension software candidate storage unit 10 stores extension software being an installation candidate. In the example illustrated in FIG. 3, as one example, extension software A, extension software B, extension software C, and . . . are stored. The extension software is formed of an archive file including, as one file, a program file formed of a plurality of programs and setting information data formed of a data file in which setting information is described. For example, the extension software A is formed of an archive file including, as one file, a program file A and setting information data A. The program file is formed of a command file in which a command (processing) for the controller is described, a screen file and an image file that are used for a screen display of an indicator of the teaching pendant 2 or an external device, and the like, and the program file is a program main body directly involved in control of the extension function. For example, the program file A is formed of “Command A.tp”, “Screen A.stm”, “Image A.png”, and the like, but the file names herein are merely one example, and the other file name may be used. Further, as the setting information data, information about various setting of an extension function controlled by the extension software is defined, and, for example, setting information about a supply voltage of a connection apparatus, setting information about communication with a connection apparatus, setting information about a coordinate system of a robot, setting information about a load, the other setting information, and the like are defined.

The extension software activation/deactivation storage unit 11 stores activation/deactivation information indicating whether each piece of the extension software being the installation candidate stored in the extension software candidate storage unit 10 is activated or deactivated. The extension software activation/deactivation storage unit 11 is formed of a rewritable nonvolatile memory, and, for example, there are an SRAM, an EEPROM, and the like.

A user can perform, via a user interface via the indicator of the teaching pendant 2 or the external device, setting as to which extension software among the pieces of extension software being the installation candidates is to be activated or deactivated, and details thereof will be described later. For example, a graphical user interface (GUI) is displayed on the indicator of the teaching pendant 2, but, as the modification example, a mechanical operation button and a lamp provided on the teaching pendant 2 may serve as a user interface. Further, as an example of the indicator of the external device, there are a touch panel of a personal computer, a touch panel of a portable terminal other than the teaching pendant 2, and the like, but the other device may be used. Herein, as one example, a case where an indicator is the indicator of the teaching pendant 2 is described, but the following description can also be similarly applied to the indicator of the external device.

The program file storage unit 13 is used for storing a program file in which various processing contents about an extension function in extension software indicated to be activated in activation/deactivation information stored in the extension software activation/deactivation storage unit 11 are defined. As long as the program file storage unit 13 is a rewritable memory, the program file storage unit 13 may be a nonvolatile memory such as an SRAM or an EEPROM, or a volatile memory such as a DRAM. For the extension software including the program file stored in the program file storage unit 13, control of an extension function corresponding to the extension software by the command execution unit 21 or the screen operation processing unit 18 can be performed. In other words, since the program file of the extension software stored in the program file storage unit 13 is used for control of an extension function by the controller 1, based on an instruction of the screen operation processing unit 18 or the command execution unit 21, the program file storage unit 13 is preferably a memory that can be written and read at a high speed.

The whole setting storage unit 14 is used for storing setting information data in which various pieces of setting information about an extension function in extension software indicated to be activated in the activation/deactivation information stored in the extension software activation/deactivation storage unit 11 are defined. As long as the whole setting storage unit 14 is a rewritable memory, the whole setting storage unit 14 may be a nonvolatile memory such as an SRAM or an EEPROM, or a volatile memory such as a DRAM.

The extension software installation processing unit 12 performs installation processing on extension software indicated to be activated in the activation/deactivation information stored in the extension software activation/deactivation storage unit 11 among the pieces of extension software being the installation candidates stored in the extension software candidate storage unit 10. In other words, as the installation processing, the extension software installation processing unit 12 performs, on extension software indicated to be activated in the activation/deactivation information stored in the extension software activation/deactivation storage unit 11 among the pieces of extension software being the installation candidates stored in the extension software candidate storage unit 10, processing of writing a program file into the program file storage unit 13 and also writing setting information data into the whole setting storage unit 14. It is noted that, when there is extension software that is changed from being activated to deactivated in the activation/deactivation information stored in the extension software activation/deactivation storage unit 11, at the time of the installation processing, the extension software installation processing unit 12 performs, on the extension software changed from being activated to deactivated, processing of deleting the program file from the program file storage unit 13 and also deleting the setting information data from the whole setting storage unit 14. In this way, every time the installation processing by the extension software installation processing unit 12 is performed, a content of the activation/deactivation information stored in the extension software activation/deactivation storage unit 11 is reflected in a storage content of the program file storage unit 13 and the whole setting storage unit 14. In the examples illustrated in FIGS. 1, 4, and 11, as one example, the extension software A and the extension software C are indicated to be activated in the extension software activation/deactivation storage unit 11, and thus the program file A and the program file C are stored in the program file storage unit 13 and the setting information data A and the setting information data C are stored in the whole setting storage unit 14.

When the program file storage unit 13 and the whole setting storage unit 14 are formed of a volatile memory, the installation processing by the extension software installation processing unit 12 is performed every time the power of the controller 1 is turned on.

Further, when the program file storage unit 13 and the whole setting storage unit 14 are formed of a nonvolatile memory, the installation processing by the extension software installation processing unit 12 may be performed at any time since a content of the activation/deactivation information stored in the extension software activation/deactivation storage unit 11 is changed until the power of the controller 1 is turned on for next time, but may be performed every time the power of the controller 1 is turned on.

It is noted that the program file storage unit 13 and the whole setting storage unit 14 are assumed to be different memories, but a storage region for the program file storage unit 13 and a storage region for the whole setting storage unit 14 may be separately provided in the same memory.

In this way, the extension software installation processing unit 12 performs the installation processing on extension software indicated to be activated in the activation/deactivation information stored in the extension software activation/deactivation storage unit 11. By the installation processing, for the extension software including the program file stored in the program file storage unit 13, control of an extension function corresponding to the extension software by the command execution unit 21 or the screen operation processing unit 18 can be performed. Setting as to which extension software among the pieces of extension software being the installation candidates is to be activated or deactivated can be performed by a simple operation via the graphical user interface (GUI) displayed on the indicator of the teaching pendant 2.

In one embodiment of the present disclosure, the screen operation processing unit 18 and the screen display processing unit 17 are provided as a user interface device. The screen operation processing unit 18 displays, on the indicator of the teaching pendant 2, a setting screen that prompts setting as to whether to activate or deactivate each piece of the extension software stored in the extension software candidate storage unit 10, and acquires operation information input via the setting screen. Based on the operation information acquired by the screen operation processing unit 18, a content of the activation/deactivation information stored in the extension software activation/deactivation storage unit 11, that is, which extension software among the pieces of extension software being the installation candidates is to be activated or deactivated is set. Based on the content of the activation/deactivation information stored in the extension software activation/deactivation storage unit 11, the screen display processing unit 17 performs control for displaying, on the indicator of the teaching pendant 2, a screen indicating a state of whether each piece of the extension software stored in the extension software candidate storage unit 10 is activated or deactivated.

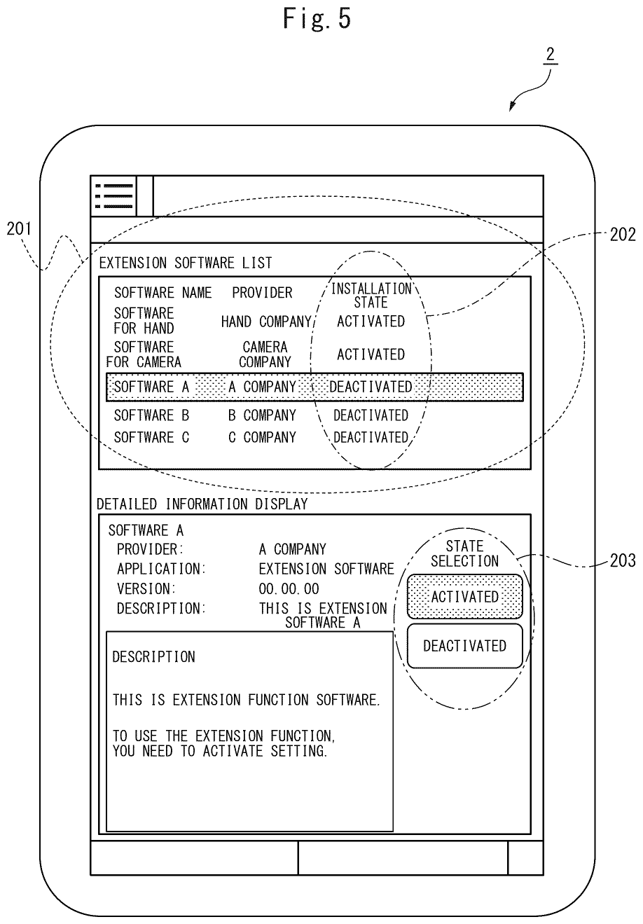

As one example, the graphical user interface (GUI) displayed on the indicator of the teaching pendant 2 will be described. FIGS. 5 to 7 are diagrams illustrating a screen displayed on the indicator of the teaching pendant by the user interface device according to one embodiment of the present disclosure.

The screen operation processing unit 18 performs control for displaying, on the indicator of the teaching pendant 2, an extension software list display item 201 indicating a list of pieces of extension software being installation candidates stored in the extension software candidate storage unit 10, an activation/deactivation information display item 202 indicating whether each piece of the extension software being the installation candidate is activated or deactivated, and a setting menu display item 203 that prompts setting as to whether to activate or deactivate each piece of the extension software being the installation candidate. The screen operation processing unit 18 controls the indicator of the teaching pendant 2 in such a way that, for extension software set to be activated via the setting menu display item 203, “activated” is displayed in the activation/deactivation information display item 202 of the extension software, and, for extension software set to be deactivated via the setting menu display item 203, “deactivated” is displayed in the activation/deactivation information display item 202 of the extension software. It is noted that the setting menu display item 203 may be displayed in a pop-up manner when a predetermined operation is performed on the screen of the teaching pendant 2.

The screen operation processing unit 18 performs control in such a way that, for extension software set to be activated via the setting menu display item 203, a program file of the extension software is written into the program file storage unit 13, and, for extension software set to be deactivated via the setting menu display item 203, a program file of the extension software is deleted from the program file storage unit 13.

In the example illustrated in FIG. 5, a list of software for hand control, software for camera, software A, software B, and software C is displayed as pieces of extension software being installation candidates in the extension software list display item 201, and it is displayed in the activation/deactivation information display item 202 that the software for hand and the software for camera are activated (installed) and the software A, the software B, and the software C are deactivated (not installed). When a user moves a cursor to a row of the software A, the setting menu display item 203 in which an activation button and a deactivation button are displayed is displayed in a pop-up manner together with detailed information about the software A on a lower portion of the screen of the indicator of the teaching pendant 2. Since the software A is not installed (deactivated) at this point in time, the activation button is displayed in an emphasized manner to be selectable (pushable) in a dark tone, whereas the deactivation button is displayed in a light tone.

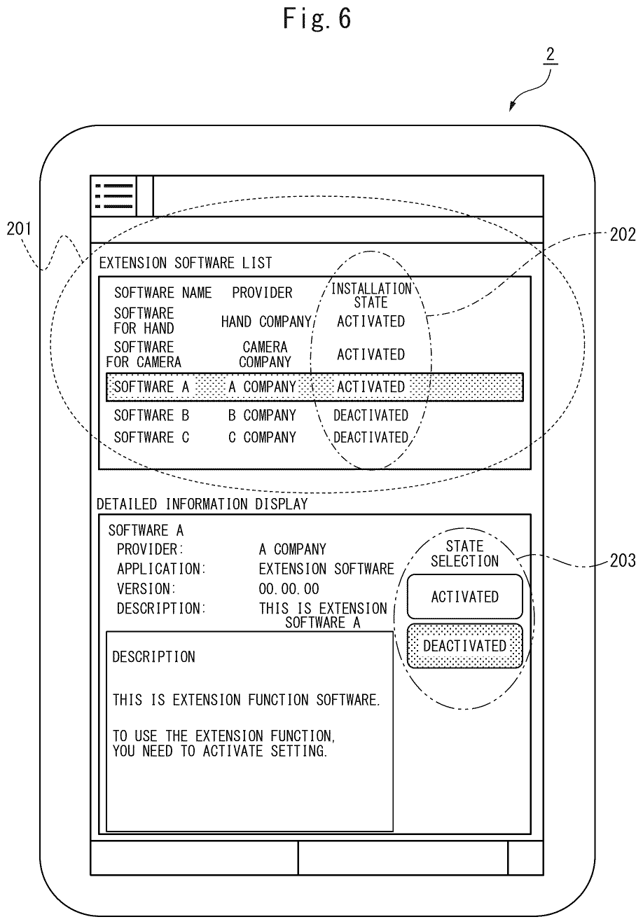

When the user selects (pushes) the activation button of the setting menu display item 203 in FIG. 5, “activated” is displayed in the software A of the activation/deactivation information display item 202 as illustrated in FIG. 6. Since the software A is installed (activated) at this point in time, the activation button is displayed in a light tone, whereas the deactivation button is displayed in an emphasized manner to be selectable (pushable) in a dark tone.

It is noted that, when the user selects (pushes) the deactivation button of the software A of the setting menu display item 203 in FIG. 6 again, “deactivated” is displayed in the software A of the activation/deactivation information display item 202 as illustrated in FIG. 5. Since the software A is not installed (deactivated) again at this point, the activation button is displayed in an emphasized manner to be selectable (pushable) in a dark tone, whereas the deactivation button is displayed in a light tone.

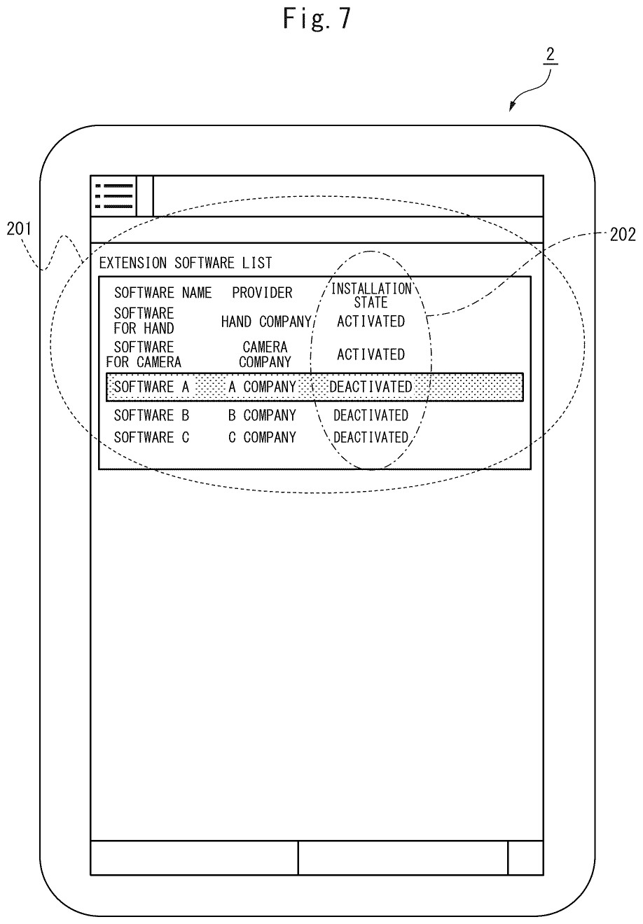

The display content and the display method illustrated in FIGS. 5 and 6 are merely one example, and a display content and a display method may be appropriately customized according to a purpose. For example, as illustrated in FIG. 7, a display mode for only a purpose of confirming an installation situation of extension software may be provided in such a way that the extension software list display item 201 and the activation/deactivation information display item 202 are displayed and the setting menu display item 203 is not displayed on the indicator of the teaching pendant 2, based on a content of the activation/deactivation information stored in the extension software activation/deactivation storage unit 11. In this way, extension software can be prevented from being accidentally installed on the controller 1 or can also be prevented from being deleted from the controller.

Further, in order to more reliably prevent extension software from being accidentally installed on the controller 1 or from being deleted from the controller, an authentication unit may be provided in the controller 1, and rewriting of the extension software activation/deactivation storage unit 11 may be permitted only when authentication is achieved.

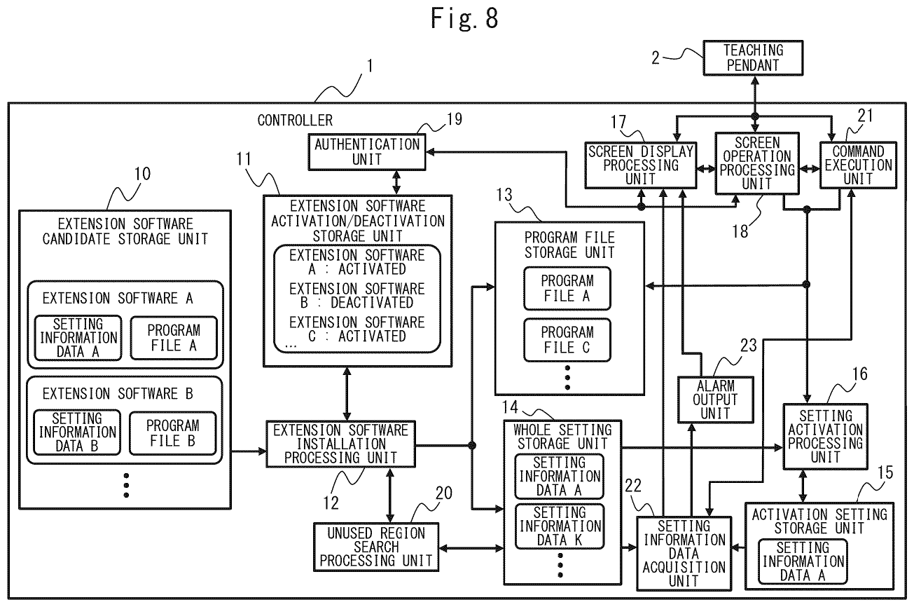

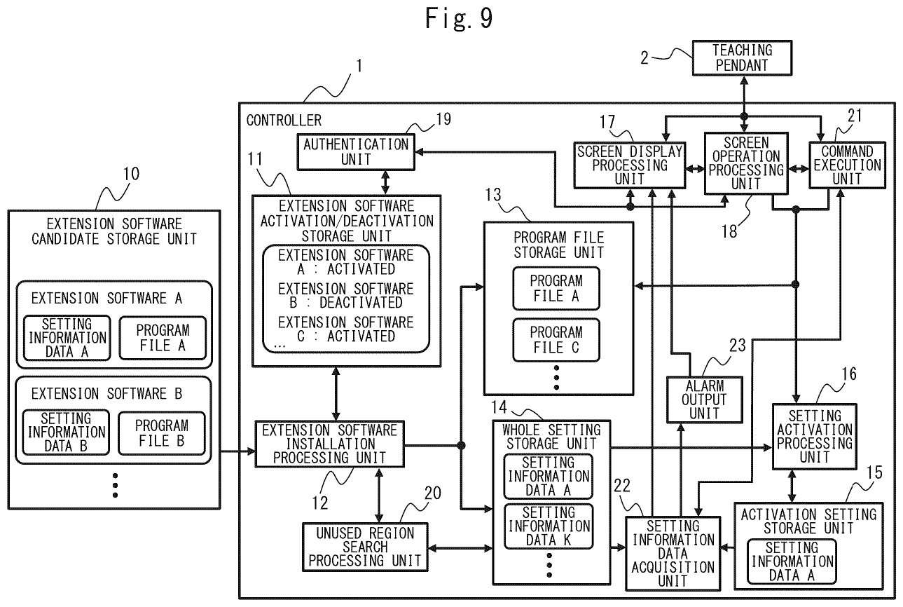

FIGS. 8 and 9 are block diagrams illustrating the controller further including the authentication unit in a modification example of one embodiment of the present disclosure, FIG. 8 illustrates a case where the extension software candidate storage unit is provided in the controller, and FIG. 9 illustrates a case where the extension software candidate storage unit is provided outside the controller.

As illustrated in FIGS. 8 and 9, the controller 1 further includes an authentication unit 19 configured to authenticate user authority, based on acquired authentication information. When authentication is achieved, the authentication unit 19 permits the screen operation processing unit 18 to change a content of the activation/deactivation information stored in the extension software activation/deactivation storage unit 11, and, when authentication by the authentication unit 19 is not achieved, the authentication unit 19 forbids the screen operation processing unit 18 to change a content of the activation/deactivation information stored in the extension software activation/deactivation storage unit 11.

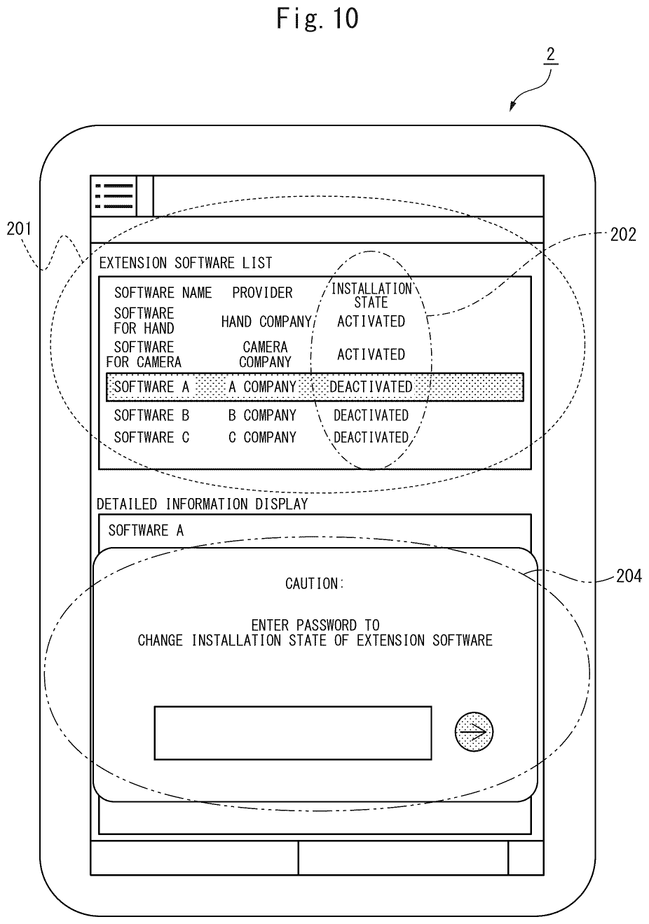

As one example, an authentication screen displayed on the indicator of the teaching pendant 2 will be described. FIG. 10 is a diagram illustrating an authentication screen displayed on the indicator of the teaching pendant by the user interface device according to one embodiment of the present disclosure.

For example, when a user moves a cursor to the row of the software A in a state where the extension software list display item 201 and the activation/deactivation information display item 202 are displayed on the indicator of the teaching pendant 2 as illustrated in FIG. 7, the screen operation processing unit 18 performs control for displaying, in a pop-up manner, an authentication screen 204 that prompts an input of authentication information on a display device as illustrated in FIG. 10. When the user inputs a password (or a passcode) as authentication information (key) onto the authentication screen 204, the password is sent to the authentication unit 19. The authentication unit 19 authenticates user authority, based on the acquired password. The authentication unit 19 determines whether the acquired password coincides with predefined key information (authentication is achieved) or not (authentication is not achieved). When authentication by the authentication unit 19 is achieved, the authentication unit 19 permits the screen operation processing unit 18 to change a content of the activation/deactivation information stored in the extension software activation/deactivation storage unit 11, and displays the setting menu display item 203 illustrated in FIG. 5 on the indicator of the teaching pendant 2. When authentication by the authentication unit 19 is not achieved, the authentication unit 19 forbids the screen operation processing unit 18 to change a content of the activation/deactivation information stored in the extension software activation/deactivation storage unit 11, and does not display the setting menu display item 203 on the indicator of the teaching pendant 2.

It is noted that, as an authentication method by the authentication unit 19, for example, a biometric authentication (biometrics) method such as voice authentication, face authentication, fingerprint authentication, palm print authentication, palm vein authentication, iris authentication, and retina authentication may be used in addition to the password (passcode) authentication method. When voice authentication is used as the authentication method, a microphone is preferably provided in the teaching operation pane 2. When face authentication, fingerprint authentication, palm print authentication, palm vein authentication, iris authentication, or retina authentication is used as the authentication method, a camera or an image sensor is preferably provided in the teaching operation pane 2.

As described above, in one embodiment of the present disclosure, extension software selected as extension software needed to be activated from among a piece of extension software being installation candidates stored in the extension software candidate storage unit 10 is installed on the controller 1.

When a plurality of program files are stored in the program file storage unit 13 in order to install a plurality of pieces of extension software at the same time on one controller for different applications, all of the program files stored in the program file storage unit 13 can be executed based on a command from the teaching pendant 2. However, when setting information data corresponding to each of the program files stored in the program file storage unit 13 are used at the time of execution of extension software, there is a possibility that the setting information data about each piece of the extension software may compete and a malfunction and a failure may occur in a robot. Thus, furthermore, in the embodiment of the present disclosure, in order to more reliably reduce a possibility of a malfunction and a failure in a robot due to competition between pieces of setting information data, setting information data stored in the whole setting storage unit 14 can be selectively activated by the installation processing, and the controller 1 can “appropriately” control an extension function of the robot. Hereinafter, activation processing of setting information data will be described.

The whole setting storage unit 14 is used for storing setting information data about at least one piece of extension software that is indicated to be activated in the activation/deactivation information stored in the extension software activation/deactivation storage unit 11 and is installed on the controller 1 by the extension software installation processing unit 12.

The unused region search processing unit 20 searches for an unused storage region in the whole setting storage unit 14 when the installation processing by the extension software installation processing unit 12 is performed and extension software is installed on the controller. The unused storage region is a region where setting information data are not yet stored among storage regions in the whole setting storage unit 14.

As the installation processing, the extension software installation processing unit 12 performs processing of writing, into an unused storage region found by the unused region search processing unit 20, setting information data about extension software indicated to be activated in the activation/deactivation information stored in the extension software activation/deactivation storage unit 11 among the pieces of extension software being the installation candidates stored in the extension software candidate storage unit 10. In this way, since setting information data about newly installed extension software are written into an unused storage region in the installation processing by the extension software installation processing unit 12, setting information data about extension software that has already been installed are not overwritten. It is noted that, when there is extension software being changed from being activated to deactivated in the activation/deactivation information stored in the extension software activation/deactivation storage unit 11, at the time of the installation processing, the extension software installation processing unit 12 performs, on the extension software changed from being activated to deactivated, processing of deleting the setting information data from the whole setting storage unit 14.

The activation setting storage unit 15 is used for storing setting information data to be used when an extension function is controlled based on extension software installed on the controller 1. Since the setting information data about the extension software stored in the activation setting storage unit 15 are used for control of an extension function by the controller 1, based on an instruction of the screen operation processing unit 18 or the command execution unit 21, the activation setting storage unit 15 is preferably a memory that can be read at a high speed. The activation setting storage unit 15 is formed of a rewritable nonvolatile memory such as an SRAM or an EEPROM.

According to operation information by the screen operation processing unit 18 or a command by the command execution unit 21, the setting activation processing unit 16 performs processing of writing, into the activation setting storage unit 15, setting information data that are selected from among pieces of setting information data stored in the whole setting storage unit 14 and need to be activated, and also deleting setting information data that need to be deactivated from the activation setting storage unit 15.

Setting as to which setting information data about extension software among pieces of installed extension software is to be activated or deactivated can be manually performed by a simple operation via the graphical user interface (GUI) displayed on the indicator of the teaching pendant 2, or can be performed by the command execution unit 21 automatically executing a program related to setting activation processing defined on a teaching program.

Herein, an aspect in which a user manually performs activation setting of setting information data will be described.

In order for the user to easily perform setting as to whether to activate or deactivate setting information data, the screen operation processing unit 18 being the user interface device displays, on the indicator of the teaching pendant 2, a screen for performing setting as to whether to activate or deactivate setting information data. More details are as follows.

The screen operation processing unit 18 displays, on the indicator of the teaching pendant 2, a setting screen that prompts setting as to whether to activate or deactivate each piece of setting information data stored in the whole setting storage unit 14, and acquires operation information input via the setting screen by the user. Based on the operation information acquired by the screen operation processing unit 18, the setting activation processing unit 16 performs processing of reading setting information data that need to be activated from the whole setting storage unit 14 and writing the setting information data into the activation setting storage unit 15, and also deleting setting information data that need to be deactivated from the activation setting storage unit 15.

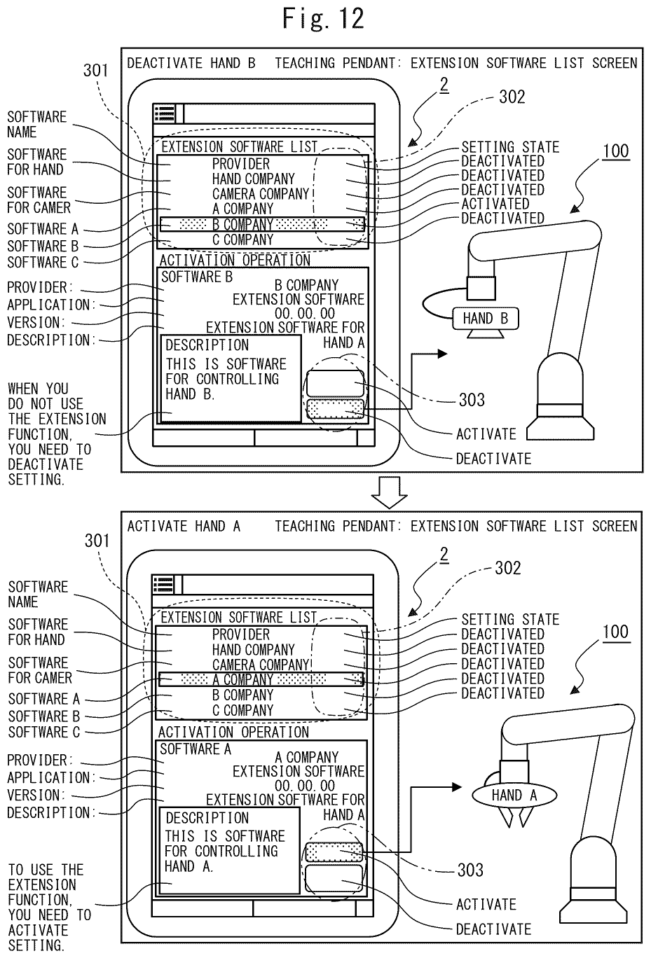

As one example, an activation setting screen of setting information data displayed on the indicator of the teaching pendant 2 will be described. FIG. 12 is a diagram illustrating the activation setting screen of setting information data displayed on the indicator of the teaching pendant by the user interface device according to one embodiment of the present disclosure. Herein, an example in which a hand B connected to a robot 100 is manually detached and replaced with a hand A will be described.

The screen operation processing unit 18 performs control for displaying, on the indicator of the teaching pendant 2, a setting information data list display item 301 indicating a list of pieces of setting information data in which various pieces of setting information about an extension function of at least one piece of extension software installed on the controller 1 are defined, an activation/deactivation information display item 302 indicating whether each piece of the setting information data in the setting information data list display item 301 is activated or deactivated, and a setting menu display item 303 that prompts setting as to whether to activate or deactivate each piece of the setting information data in the setting information data list display item 301. It is noted that the setting menu display item 303 may be displayed in a pop-up manner when a predetermined operation is performed on the screen of the teaching pendant 2.

The screen operation processing unit 18 performs control in such a way that setting information data that are selected from among pieces of setting information data via the setting menu display item 303 and need to be activated are written into the activation setting storage unit 15 configured to store setting information data used when an extension function is controlled based on installed extension software, and the screen operation processing unit 18 performs control in such a way that setting information data that are selected from among the pieces of setting information data via the setting menu display item 303 and need to be deactivated are deleted from the activation setting storage unit 15. In this way, the setting information data in the extension software installed on the controller 1 are selectively activated.

In an upper row in FIG. 12, a state where the hand B is connected to the robot 100 and setting information data about the software B as extension software for controlling the hand B are activated is illustrated. As illustrated in the upper row in FIG. 12, on the indicator of the teaching pendant 2, a list of setting information data about the software for hand, the software for camera, the software A, the software B, and the software C is displayed as installed extension software in the setting information data list display item 301, and it is displayed in the activation/deactivation information display item 302 that only the setting information data about the software B being the extension software for controlling the hand B connected to the robot 100 are activated and each piece of the setting information data about the software for hand, the software for camera, the software A, and the software C is deactivated. Before the hand B is detached from the robot 100, the user moves a cursor to a row of the software B. Then, the setting menu display item 303 in which an activation button and a deactivation button are displayed is displayed in a pop-up manner together with detailed information about the software B on the lower portion of the screen of the indicator of the teaching pendant 2. Since the setting information data about the software B are activated at this point in time, the activation button is displayed in a light tone, whereas the deactivation button is displayed in an emphasized manner to be selectable (pushable) in a dark tone.

When the user selects (pushes) the deactivation button of the setting menu display item 303, the screen operation processing unit 18 performs control in such a way that the setting information data about the software B are deleted from the activation setting storage unit 15, and also performs control in such a way that it is displayed in the activation/deactivation information display item 302 on the indicator of the teaching pendant 2 that each piece of the setting information data about the software for hand, the software for camera, the software A, the software B, and the software C is deactivated as illustrated on a lower row in FIG. 12. In order to activate the setting information data about the software A being extension software for controlling the hand A connected to the robot 100, the user moves a cursor to a row of the software A. Then, the setting menu display item 303 in which the activation button and the deactivation button are displayed is displayed in a pop-up manner together with detailed information about the software A on the lower portion of the screen of the indicator of the teaching pendant 2. In the setting information data about the software A, the activation button is displayed in an emphasized manner to be selectable (pushable) in a dark tone at this point in time, whereas the deactivation button is displayed in a light tone. When the user selects (pushes) the activation button of the setting menu display item 303, the screen operation processing unit 18 performs control in such a way that the setting information data about the software A are read from the whole setting storage unit 14 and written into the activation setting storage unit 15, and also performs control in such a way that it is displayed in the activation/deactivation information display item 302 on the indicator of the teaching pendant 2 that only the setting information data about the software A are activated and each piece of the setting information data about the software for hand, the software for camera, the software B, and the software C is deactivated although not illustrated. In this way, the controller 1 can appropriately control the hand A of the robot 100, based on the setting information data A about the software A being the extension software.

Next, an aspect in which activation setting of setting information data is automatically performed according to an automatic change (for example, a tool change) of a connection apparatus of a robot will be described.

As one example, a tool change operation in which detachment of the hand B and attachment of the hand A with respect to the robot 100 are automatically performed based on a teaching program will be described.

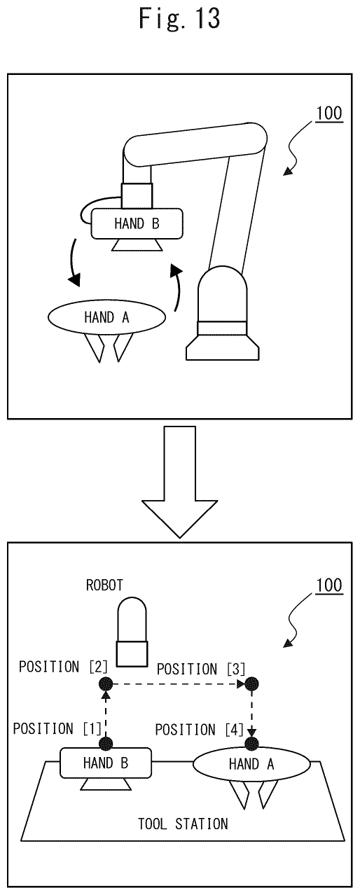

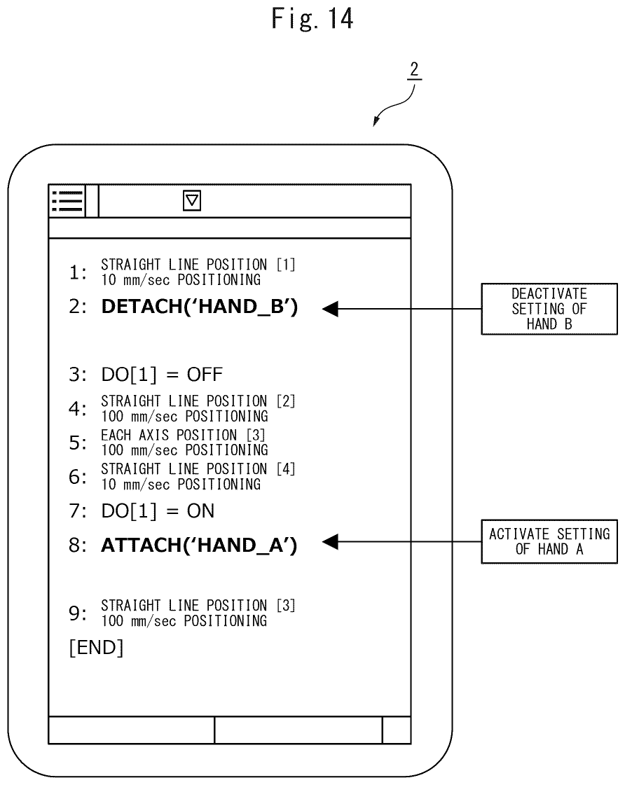

FIG. 13 is a diagram illustrating a series of flows of detachment of the hand B and attachment of the hand A with respect to the robot. Further, FIG. 14 is a diagram illustrating the teaching pendant that displays a teaching program for controlling detachment of the hand B and attachment of the hand A illustrated in FIG. 13.

In the tool change operation in which the hand B is detached from the robot 100 and replaced with the hand A, for example, as illustrated in FIG. 13, a tip (to which the hand B is connected at this point in time) of an arm of the robot 100 is first moved to “position [1]” on a tool station, detachment processing of the hand B is performed when the hand B arrives “position [1]”, and processing of deactivating the setting information data about the hand B is performed. Next, the tip of the arm of the robot 100 is moved in order of “position [2]”, “position [3]”, and “position [4]”, attachment processing of the hand A is performed when the tip of the arm of the robot 100 arrives “position [4]” on the tool station, and processing of activating the setting information data about the hand A is performed. Then, processing of moving the tip (to which the hand A is connected at this point in time) of the arm of the robot 100 to “position [3]” is performed.

The tool change operation expressed by a teaching program is as illustrated in FIG. 14. A command for a movement to “position [1]” of the tool station is defined in a first row of the teaching program, a command for detaching the hand B from the tip of the arm of the robot 100 is defined in a second row, and a command “DO [1]=OFF” for releasing an automatic tool change (ATC) lock is defined in a third row. A command for moving the tip of the arm of the robot 100 to “position [2]” is defined in a fourth row of the teaching program, a command for moving the tip of the arm of the robot 100 to “position [3]” is defined in a fifth row, and a command for moving the tip of the arm of the robot 100 to “position [4]” is defined in a sixth row. A command “DO [1]=ON” of the ATC lock is defined in a seventh row of the teaching program, a command for attaching the hand A to the tip of the arm of the robot 100 is defined in an eighth row, and a command for moving the tip of the arm of the robot 100 to “position [3]” is defined in a ninth row.

In order to automatically perform deactivation processing of the setting information data about the hand B and activation processing of the setting information data about the hand A according to the series of processing of such a tool change operation, a command for defining the deactivation processing of the setting information data about the hand B is inserted in advance between the second row and the third row of the teaching program described above, and a command for defining the activation processing of the setting information data about the hand A is inserted in advance between the eighth row and the ninth row of the teaching program.

The command execution unit 21 executes the teaching program defined as described above, and thus tool change processing of a connection apparatus of the robot 100 and activation setting processing of setting information data are automatically performed without involvement by an operation of a user. Particularly in regard to a teaching program portion related to the activation setting processing of setting information data, the command execution unit 21 executes the teaching program that performs, on the setting activation processing unit 16, a command for writing, into the activation setting storage unit 15, setting information data that are selected from among pieces of setting information data stored in the whole setting storage unit 14 and need to be activated, and a command for deleting, from the activation setting storage unit 15, setting information data that are selected from among the pieces of setting information data stored in the whole setting storage unit 14 and need to be deactivated.

A setting state of whether setting information data about extension software being manually or automatically set as described above are activated or deactivated can be displayed on the screen of the indicator of the teaching pendant 2 as necessary.

For example, when a user performs, by using the teaching pendant 2, an operation in such a way that “display of a setting state of setting information data” is performed, the teaching pendant 2 instructs the setting information data acquisition unit 22 to acquire setting information. In response to this, the setting information data acquisition unit 22 acquires information about setting information data stored in the whole setting storage unit 14 and setting information data stored in the activation setting storage unit 15. According to the information acquired by the setting information data acquisition unit 22, the screen display processing unit 17 performs control for displaying, on the indicator of the teaching pendant 2, a screen indicating a setting state of whether each piece of the setting information data stored in the whole setting storage unit is activated or deactivated. In other words, the screen display processing unit 17 being the user interface device controls the indicator of the teaching pendant 2 in such a way that, for setting information data (that is, setting information data stored in both of the whole setting storage unit 14 and the activation setting storage unit 15) being set to be activated, “activated” is displayed in the activation/deactivation information display item 302 of the setting information data, and, for setting information data (that is, setting information data that are stored in the whole setting storage unit 14 and are not stored in the activation setting storage unit 15) being set to be deactivated, “deactivated” is displayed in the activation/deactivation information display item 302 of the setting information data.

The display content and the display method illustrated in FIGS. 12 and 14 are merely one example, and a display content and a display method may be appropriately customized according to a purpose.

As described above, a program file stored in the program file storage unit 13 can be executed based on an instruction from the teaching pendant 2. However, when setting information data corresponding to the program file stored in the program file storage unit 13 are not activated, control of the robot 100 cannot be appropriately performed. In order to avoid such a situation, the teaching pendant 2 may be caused to perform an operation as follows.

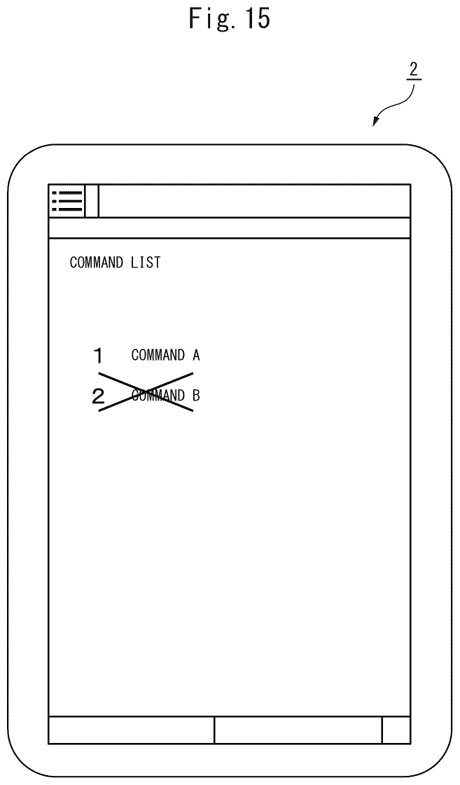

FIG. 15 is a diagram illustrating a screen of the indicator of the teaching pendant in which information about a command of extension software for setting information data not being activated is hidden by the user interface device according to one embodiment of the present disclosure.

Since extension software whose setting information data are not activated are not assumed to be executed, information about the extension software whose setting information data are not activated may be hidden on the indicator of the teaching pendant 2. The setting information data acquisition unit 22 acquires information about setting information data stored in the whole setting storage unit 14 and setting information data stored in the activation setting storage unit 15. According to the information acquired by the setting information data acquisition unit 22, the screen display processing unit 17 being the user interface device hides, on the screen of the indicator of the teaching pendant 2, information about extension software corresponding to setting information data that are not stored in the activation setting storage unit 15. For example, the example illustrated in FIG. 15 illustrates a case where the setting information data about the extension software A including a command A are activated, and the setting information data about the extension software B including a command B are deactivated, and, in this case, the screen display processing unit 17 performs control for displaying information about the command A and hiding information about the command B on a command list screen. In this way, a user cannot recognize information about extension software whose setting information data are not activated via the teaching pendant 2, and thus execution of the extension software whose setting information data are not activated can be avoided. It is noted that, in FIG. 15, in order to facilitate understanding, a fact that the command B is not displayed is schematically expressed by an “X sign on characters of the command B”, but the “command B” is actually hidden.

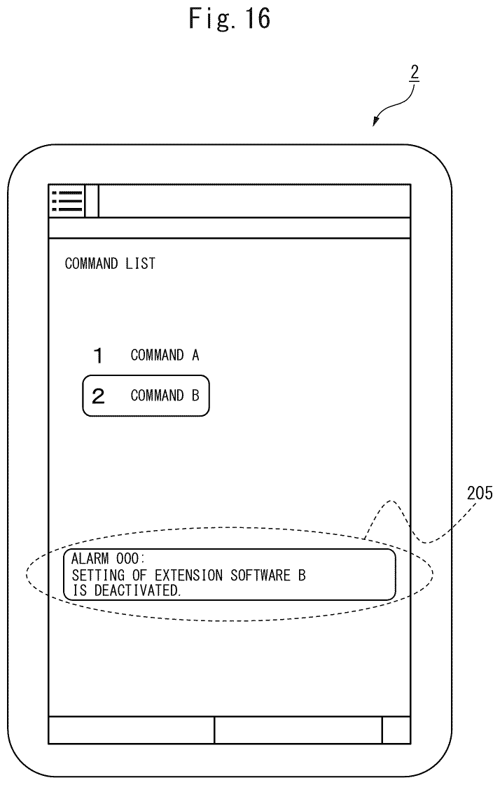

FIG. 16 is a diagram illustrating a screen when an alarm about execution of extension software for setting information data not being activated is displayed on the indicator of the teaching pendant by the user interface device according to one embodiment of the present disclosure.

Since extension software whose setting information data are not activated are not assumed to be executed, an alarm may be displayed on the indicator of the teaching pendant 2 when execution of the extension software whose setting information data are not activated is instructed by an operation of the teaching pendant 2. The setting information data acquisition unit 22 acquires information about setting information data stored in the whole setting storage unit 14 and setting information data stored in the activation setting storage unit 15. The alarm output unit 23 outputs an alarm when execution of extension software corresponding to setting information data that are not stored in the activation setting storage unit 15 (that is, setting information data that are not activated) is detected based on a content acquired by the setting information data acquisition unit 22. The screen display processing unit 17 being the user interface device performs control for displaying, on the indicator of the teaching pendant 2, alarm information 205 indicating execution of the extension software corresponding to the setting information data that are not stored in the activation setting storage unit 15. In this way, a user can recognize execution of a command of extension software whose setting information data are not activated via the teaching pendant 2, and thus execution of the extension software whose setting information data are not activated can be avoided, and the user can take action by changing setting information data that need to be activated as necessary. For example, the example illustrated in FIG. 16 illustrates a case where the setting information data about the extension software A including the command A are activated and a button that instructs execution of the command B of the extension software B whose setting information data are deactivated is selected (pushed), and, in this case, the alarm output unit 23 outputs an alarm, and, in response to this, the screen display processing unit 17 performs control for displaying “alarm 000: setting of extension software B is deactivated.” as the alarm information 205 on the indicator of the teaching pendant 2. It is noted that the display content and the display method of the alarm information 205 illustrated in FIG. 16 are merely one example, and the other display content and display method may be used as long as the display content and the display method attract attention of a user, and alarm information may be displayed on a different screen such as a program teaching screen, for example.

An arithmetic processing device (processor) is provided in the controller 1 described above. As the arithmetic processing device, for example, there are an IC, an LSI, a CPU, an MPU, a DSP, and the like. The arithmetic processing device includes the extension software installation processing unit 12, the setting activation processing unit 16, the screen display processing unit 17, the screen operation processing unit 18, the authentication unit 19, the unused region search processing unit 20, the command execution unit 21, the setting information data acquisition unit 22, and the alarm output unit 23. Each of these units included in the arithmetic processing device is, for example, a functional module achieved by a computer program executed on a processor. For example, when the extension software installation processing unit 12, the setting activation processing unit 16, the screen display processing unit 17, the screen operation processing unit 18, the authentication unit 19, the unused region search processing unit 20, the command execution unit 21, the setting information data acquisition unit 22, and the alarm output unit 23 are constructed in a computer program form, a function of each of the units can be achieved by operating the arithmetic processing device according to the computer program. The computer program for performing each processing of the extension software installation processing unit 12, the setting activation processing unit 16, the screen display processing unit 17, the screen operation processing unit 18, the authentication unit 19, the unused region search processing unit 20, the command execution unit 21, the setting information data acquisition unit 22, and the alarm output unit 23 may be provided in a form of being recorded in a computer-readable recording medium such as a semiconductor memory, a magnetic recording medium, or an optical recording medium. Further, alternatively, the extension software installation processing unit 12, the setting activation processing unit 16, the screen display processing unit 17, the screen operation processing unit 18, the authentication unit 19, the unused region search processing unit 20, the command execution unit 21, the setting information data acquisition unit 22, and the alarm output unit 23 may be achieved as a semiconductor integrated circuit in which a computer program that achieves a function of each of the units is written. Further, the extension software candidate storage unit 10, the extension software activation/deactivation storage unit 11, the program file storage unit 13, the whole setting storage unit 14, and the activation setting storage unit 15 are formed in various storage devices described above.

According to one embodiment of the present disclosure, in a controller that controls an extension function of a robot or a machine tool, based on installed extension software, and a user interface device, desired extension software can be selectively installed by a simple operation without occurrence of a malfunction and a failure due to an interaction between pieces of extension software and competition between pieces of setting information.

According to one embodiment of the present disclosure, only necessary extension software can be selectively activated again by a simple operation and installed on a controller when an application using a robot is determined. Similarly, only necessary setting information data can be selectively activated by a simple operation. Therefore, a memory source (particularly, an expensive SRAM and the like) in a controller is not uselessly consumed, which is economical. Further, a malfunction and a failure due to an interaction between pieces of extension software and competition between pieces of setting information about extension software can be avoided.

Further, according to one embodiment of the present disclosure, whether or not to install extension software and whether to activate or deactivate setting information data can be easily set, and each setting state can also be easily confirmed, which is highly convenient. Further, extension software whose setting information data are not activated is displayed on an indicator of a teaching pendant, or an alarm is displayed even when execution is instructed, and thus execution of the extension software whose setting information data are not activated can be avoided, and control of a robot can be appropriately performed.

Furthermore, according to one embodiment of the present disclosure, extension software can be prevented from being accidentally installed on a controller or can be prevented from being deleted from the controller by providing an authentication unit. Further, a charging system can be constructed in the controller when the authentication unit is provided.

As described above, the case where the controller 1 is the robot controller that controls the robot 100 is described, but the description described above can also be similarly applied to a numerical controller that controls a machine tool.

### REFERENCE SIGNS LIST

1 Controller
2 Teaching pendant
10 Extension software candidate storage unit
11 Extension software activation/deactivation storage unit
12 Extension software installation processing unit
13 Program file storage unit
14 Whole setting storage unit
15 Activation setting storage unit
16 Setting activation processing unit
17 Screen display processing unit
18 Screen operation processing unit
19 Authentication unit
20 Unused region search processing unit
21 Command execution unit
22 Setting information data acquisition unit
100 Robot
201 Extension software list display item
202 Activation/deactivation information display item
203 Setting menu display item
204 Authentication screen
205 Alarm information
301 Setting information data list display item
302 Activation/deactivation information display item
303 Setting menu display item

1. A controller that controls an extension function of a robot or a machine tool, based on installed extension software, the controller comprising:
an extension software activation/deactivation storage unit configured to store activation/deactivation information indicating whether each piece of the extension software stored in an extension software candidate storage unit configured to store the extension software being an installation candidate is activated or deactivated; and
an extension software installation processing unit configured to perform installation processing on extension software indicated to be activated in the activation/deactivation information stored in the extension software activation/deactivation storage unit among the pieces of extension software stored in the extension software candidate storage unit.

2. The controller according to claim 1, further comprising
a program file storage unit configured to store a program file in which various processing contents about the extension function in the extension software are defined, wherein,
as the installation processing, the extension software installation processing unit performs processing of writing, into the program file storage unit, a program file in extension software indicated to be activated in the activation/deactivation information stored in the extension software activation/deactivation storage unit among the pieces of extension software stored in the extension software candidate storage unit.

3. The controller according to claim 2, further comprising
a whole setting storage unit configured to store setting information data in which various pieces of setting information about the extension function in the extension software are defined, wherein,
as the installation processing, the extension software installation processing unit performs processing of writing, into the whole setting storage unit, setting information data in extension software indicated to be activated in the activation/deactivation information stored in the extension software activation/deactivation storage unit among the pieces of extension software stored in the extension software candidate storage unit.

4. The controller according to claim 1, wherein
the extension software installation processing unit performs the installation processing every time the power of the controller is turned on.

5. The controller according to claim 1, wherein
the extension software installation processing unit performs the installation processing at any time since a content of the activation/deactivation information stored in the extension software activation/deactivation storage unit is changed until the power of the controller is turned on for next time.

6. The controller according to claim 1, further comprising
a screen display processing unit configured to display, on an indicator of a teaching pendant or an external device, a screen indicating a state of whether each piece of the extension software stored in the extension software candidate storage unit is activated or deactivated, based on a content of the activation/deactivation information stored in the extension software activation/deactivation storage unit.

7. The controller according to claim 1, further comprising
a screen operation processing unit configured to display, on an indicator of a teaching pendant or an external device, a setting screen that prompts setting as to whether to activate or deactivate each piece of the extension software stored in the extension software candidate storage unit, and acquire operation information input via the setting screen, wherein
a content of the activation/deactivation information stored in the extension software activation/deactivation storage unit is set based on the operation information acquired by the screen operation processing unit.

8. The controller according to claim 1, further comprising
an authentication unit configured to authenticate user authority, based on acquired authentication information, wherein,
when authentication by the authentication unit is achieved, a change in a content of the activation/deactivation information stored in the extension software activation/deactivation storage unit is permitted, and, when authentication by the authentication unit is not achieved, a change in a content of the activation/deactivation information stored in the extension software activation/deactivation storage unit is forbidden.

9. The controller according to claim 1, wherein
the extension software activation/deactivation storage unit is formed of a rewritable nonvolatile memory.

10. A controller that controls an extension function of a robot or a machine tool, based on installed extension software, the controller comprising:
a whole setting storage unit configured to store, for at least one piece of extension software installed on the controller, setting information data in which various pieces of setting information about the extension function in the extension software are defined;
an activation setting storage unit configured to store setting information data to be used when the extension function is controlled based on extension software installed on the controller; and
a setting activation processing unit configured to write, into the activation setting storage unit, setting information data that are selected from among pieces of the setting information data stored in the whole setting storage unit and need to be activated.

11. The controller according to claim 10, wherein
setting information data in extension software installed on the controller are selectively activated.

12. The controller according to claim 10, further comprising:
an unused region search processing unit configured to search for an unused storage region in the whole setting storage unit when extension software is installed on the controller; and
an extension software installation processing unit configured to write setting information data in the extension software into the unused storage region found by the unused region search processing unit.

13. The controller according to claim 10, further comprising
a screen operation processing unit configured to display, on an indicator of a teaching pendant or an external device, a setting screen that prompts setting as to whether to activate or deactivate each piece of the setting information data stored in the whole setting storage unit, and acquire operation information input via the setting screen, wherein
the setting activation processing unit performs processing of writing setting information data that need to be activated into the activation setting storage unit, and also deleting setting information data that need to be deactivated from the activation setting storage unit, based on the operation information acquired by the screen operation processing unit.

14. The controller according to claim 10, further comprising
a command execution unit configured to execute a teaching program that performs, on the setting activation processing unit, a command for the setting activation processing unit to write, into the activation setting storage unit, setting information data that are selected from among the pieces of setting information data stored in the whole setting storage unit and need to be activated, and a command for the setting activation processing unit to delete, from the activation setting storage unit, setting information data that are selected from among the pieces of setting information data stored in the whole setting storage unit and need to be deactivated.

15. The controller according to claim 10, further comprising:
a setting information data acquisition unit configured to acquire the setting information data stored in the whole setting storage unit and the setting information data stored in the activation setting storage unit; and
a screen display processing unit configured to display, on an indicator of a teaching pendant or an external device, a screen indicating a state of whether each piece of the setting information data stored in the whole setting storage unit is activated or deactivated, according to a content acquired by the setting information data acquisition unit.

16. The controller according to claim 10, further comprising:
a setting information data acquisition unit configured to acquire the setting information data stored in the whole setting storage unit and the setting information data stored in the activation setting storage unit; and
a screen display processing unit configured to hide, on a screen of an indicator of a teaching pendant or an external device, information about the extension software corresponding to setting information data that are not stored in the activation setting storage unit, based on a content acquired by the setting information data acquisition unit.

17. The controller according to claim 10, further comprising:
a setting information data acquisition unit configured to acquire the setting information data stored in the whole setting storage unit and the setting information data stored in the activation setting storage unit; and
an alarm output unit configured to output an alarm when execution of the extension software corresponding to setting information data that are not stored in the activation setting storage unit is detected based on a content acquired by the setting information data acquisition unit.

18. The controller according to claim 1, wherein
the controller is a robot controller that controls the robot or a numerical controller that controls the machine tool.

19. The controller according to claim 10, wherein
the controller is a robot controller that controls the robot or a numerical controller that controls the machine tool.

20. A user interface device for a controller that controls an extension function of a robot or a machine tool, based on installed extension software, the user interface device being configured to
perform control for displaying, on a display device, an extension software list display item indicating a list of pieces of extension software being installation candidates stored in an extension software candidate storage unit, an activation/deactivation information display item indicating whether each piece of the extension software being the installation candidate is activated or deactivated, and a setting menu display item that prompts setting as to whether to activate or deactivate each piece of the extension software being the installation candidate.

21. The user interface device according to claim 20, wherein
the user interface device controls the display device in such a way that, for extension software set to be activated via the setting menu display item, “activated” is displayed in the activation/deactivation information display item of the extension software, and, for extension software set to be deactivated via the setting menu display item, “deactivated” is displayed in the activation/deactivation information display item of the extension software.

22. The user interface device according to claim 20, wherein
the controller is controlled in such a way that a program file in which various processing contents about the extension function of extension software set to be activated via the setting menu display item are defined is written into a program file storage unit in the controller, and the controller is controlled in such a way that a program file in extension software set to be deactivated via the setting menu display item is deleted from the program file storage unit in the controller.

23. The user interface device according to claim 20, wherein
the user interface device performs control for displaying an authentication screen that prompts an input of authentication information on the display device, and
the user interface device performs control for displaying, on the display device, the setting menu display item when authentication is achieved based on authentication information acquired via the authentication screen in the controller.

24. A user interface device for a controller that controls an extension function of a robot or a machine tool, based on installed extension software, the user interface device being configured to
perform control for displaying, on a display device, a setting information data list display item indicating a list of pieces of setting information data in which various pieces of setting information about the extension function of at least one piece of extension software installed on the controller are defined, an activation/deactivation information display item indicating whether each piece of setting information data in the setting information data list display item is activated or deactivated, and a setting menu display item that prompts setting as to whether to activate or deactivate each piece of setting information data in the setting information data list display item.

25. The user interface device according to claim 24, wherein
the controller is controlled in such a way that setting information data that are selected from among pieces of the setting information data via the setting menu display item and need to be activated are written into an activation setting storage unit in the controller configured to store setting information data used when the extension function is controlled based on installed extension software, and setting information data that are selected from among the pieces of setting information data via the setting menu display item and need to be deactivated are also deleted from the activation setting storage unit.

26. The user interface device according to claim 25, wherein
the user interface device controls the display device in such a way that, for setting information data set to be activated, “activated” is displayed in the activation/deactivation information display item of the setting information data, and, for setting information data set to be deactivated, “deactivated” is displayed in the activation/deactivation information display item of the setting information data.

27. The user interface device according to claim 25, wherein
the user interface device performs control for hiding, on the display device, information about the extension software corresponding to setting information data that are not stored in the activation setting storage unit, based on a content of setting information data in the extension software installed on the controller and the setting information data stored in the activation setting storage unit.

28. The user interface device according to claim 25, wherein
the user interface device performs control for displaying alarm information on the display device when the extension software corresponding to setting information data that are not stored in the activation setting storage unit are executed in the controller.

29. The user interface device according to claim 24, wherein
the display device is an indicator of a teaching pendant or an external device.

30. The user interface device according to claim 24, wherein
the controller is a robot controller that controls the robot or a numerical controller that controls the machine tool.
